(19) United States
(12) Patent Application Publication
(10) Pub. No.: US 2010/0155494 A1
(43) Pub. Date: Jun. 24, 2010

(54) PRINT CONTAINMENT OF PIXELS TO IMPROVE READABILITY

(75) Inventors: Douglas B. Quine, Bethel, CT (US); Judith D. Auslander, Westport, CT (US)

Correspondence Address: PITNEY BOWES INC., 35 WATERVIEW DRIVE, MSC 26-22, SHELTON, CT, 06484-3000, US

(73) Assignee: Pitney Bowes inc., Stamford, CT (US)

(21) Appl. No.: 12/357,446

(22) Filed: Jan. 22, 2009

Related U.S. Application Data
(63) Continuation-in-part of application No. 12/337,778, filed on Dec. 18, 2008, now abandoned.

(51) Int. Cl. G06K 19/06

(52) U.S. Cl. 235/494

(57) ABSTRACT

A method to improve the image of a printed barcode by causing controlled “bleeding” of the print pixels within solid printed areas surrounded by a barrier to improve the print contrast ratio within the barcode data element by homogenizing the printed data without causing image bleed into unintended areas. Hence, the printed material will contain more clearly defined printed and non printed areas to enable the printed material to be accurately read.

### CROSS REFERENCE TO RELATED APPLICATIONS

This application is a continuation-in-part of commonly-owned, co-pending U.S. patent application Ser. No. 12/337,778, entitled PRINT CONTAINMENT OF PIXELS TO IMPROVE READABILITY, filed Dec. 18, 2008, (Attorney Docket Number G-492), which application is incorporated herein by reference in its entirety.

### FIELD OF THE INVENTION

The invention relates generally to the field of printing and more particularly to improving the readability of printed matter

### BACKGROUND OF THE INVENTION

Printed matter needs to be printed with a high level of quality to ensure readability by automation equipment, especially when old technology readers require very high print contrast ratios to ensure readability. The problem is particularly evident when barcodes are automatically read by postal automation equipment and other barcode readers.

Barcodes have been used in a wide variety of applications as a source for information. Typically barcodes are used at a point-of-sale terminal in merchandising for pricing and inventory control. Barcodes are also used in controlling personnel access systems, mailing systems, and in manufacturing for work-in process and inventory control systems, etc. The barcodes themselves represent numbers or alphanumeric characters by series of adjacent stripes of various widths (i.e. a universal product code), height (i.e. POSTNET barcode), or position (i.e. Data Matrix barcode)

An ordinary barcode is a set of binary numbers. It typically consists of black bars and white spaces. A wide black bar space may signify a one and a thin black bar or space may signify a zero. The binary numbers stand for decimal numbers or letters. There are several different kinds of barcodes. In each one, a number, letter or other character is formed by a pre-established number of bars and spaces.

Width modulated barcodes are “vertically redundant”, meaning that the same information is repeated vertically. They are in fact a one-dimensional code. The heights of the bars can be truncated without any lose of information. A two-dimensional code stores information along the height as well as the length of the symbol. Thus, in the same area more information may be stored in a two dimensional barcode than in a one dimensional barcode.

Current technology printers may leave small unintended voids between pixels which prevent achievement of the highest print contrast ratios which the ink dyes or pigments are theoretically capable of. Such unintended voids also degrade the perceived quality of printed images. Barcodes, in particular, are also very sensitive to ink in unwanted locations—the line of contact and the white spaces in barcodes must be preserved. Readability can be severely impacted if ink is allowed to bleed into regions which are intended to be blank.

One of the problems of the prior art is that it is often difficult to automatically read printed information.

Another problem of the prior art is that s often difficult to automatically read printed information that has a low print contrast ratio.

### SUMMARY OF THE INVENTION

This invention overcomes the disadvantages of the prior art by providing a method to improve print image quality within data elements. The foregoing is accomplished by “printing” with ink repellant, hydrophobic material, clear wax, or heat (thermal print head) around an intended data element from a first print head to create a barrier around the intended data element and then printing a desired color ink from a second print head. This barrier prevents “bleeding” of the print pixels outside the intended printed barcode data elements to improve the print contrast ratio between the barcode data element and the background. It also allows heavier print of dark pixels without causing image bleed into unintended areas. Hence, the printed material will contain more clearly defined printed and non printed areas to enable the printed material to be accurately read.

### BRIEF DESCRIPTION OF THE DRAWINGS

FIG. 1 illustrates in enlarged detail portions of code bars of an ideal one dimensional barcode;

FIG. 2 is a drawing of a two dimensional (2-d) barcode;

FIG. 3 illustrates in enlarged detail an idealized black rectangle 64 of FIG. 2;

FIG. 4 illustrates in enlarged detail a barcode data element (black rectangle 64) of FIG. 2 that comprises a matrix of 5 by 5 printed pixels;

FIG. 5 illustrates in enlarged detail a barcode data element (black rectangle) 64 of FIG. 2 that comprises a matrix of 5 by 5 printed pixels 66, showing the pixels 66 surrounded by a barrier 82;

FIG. 6 illustrates in enlarged detail a barcode data element (black rectangle) 64 of FIG. 5 that formed an almost solid black area 69 when ink was contained by barrier 82;

FIG. 7 is a process flow diagram of the printing of rectangle 64 of FIG. 6;

FIG. 8 is a drawing of the apparatus of this invention showing two print heads (ink and barrier) that print the enhanced barcode 60;

FIG. 9 is a drawing of the apparatus of this invention showing two print heads (ink and barrier) as they move across the paper 204 leaving a trail of printed enhanced barcode elements

### DETAILED DESCRIPTION OF THE PREFERRED EMBODIMENT

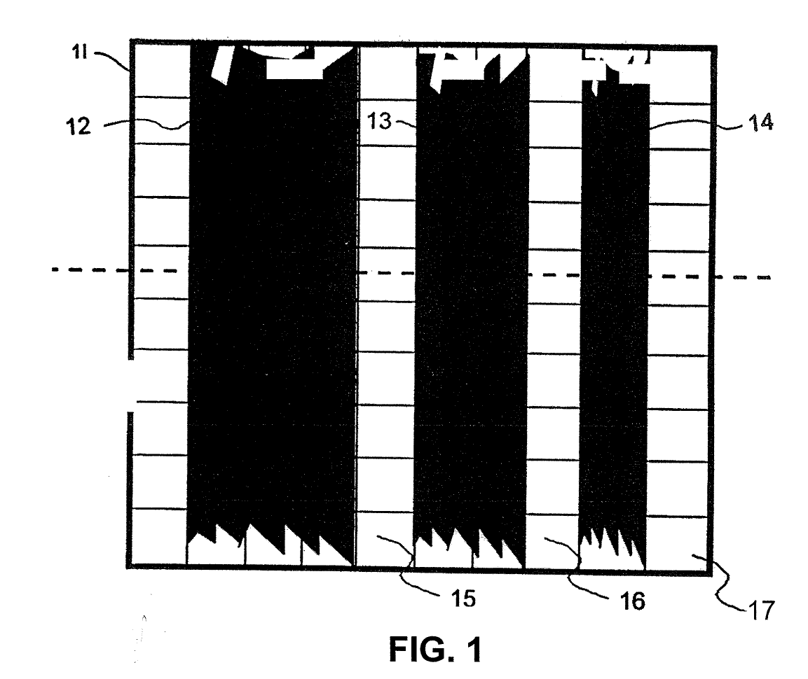

Referring now to the drawings in detail, and more particularly to FIG. 1, the reference character 11 represents an enlarged detail portion of an ideal barcode. Barcode 11 contains bars 12, 13 and 14 and spaces 15, 16 and 17. Bar 12 is three pixels wide bar 13 is two pixels wide, and bar 14 is one pixel wide. Bar 12 represents a unique number (i.e., three), bar 13 represents a unique number (i.e., two), and bar 14 represents a unique number (i.e., one). Spaces 15, 16 and 17 are one unit wide.

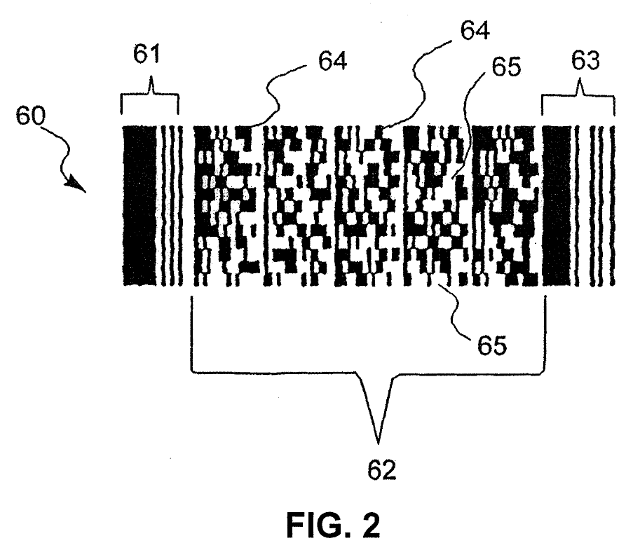

FIG. 2 is a drawing of a two dimensional (2-d) barcode 60. Barcode 60 includes: a start pattern 61, that informs a scanner (not shown) when to begin reading data; a data portion 62; and a stop pattern 63, that informs a scanner when to stop reading data. Data portion 62 comprises printed barcode data elements (rectangles) 64 and non printed barcode data elements (spaces) 65. The coded information represented by data portion 62 is contained in the relative positions of the printed (64) and non printed barcode data elements (65) that are scanned.

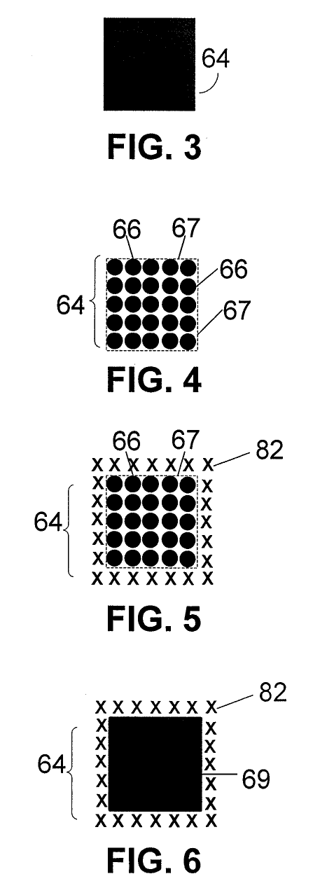

FIG. 3 illustrates in enlarged detail an idealized black rectangle 64 of FIG. 2.

FIG. 4 illustrates in enlarged detail a black rectangle 64 of FIG. 2 that comprises a matrix of 5 by 5 printed pixels 66. The printed pixels 66 have unintended voids 67 between them. The print contrast within the printed area of rectangle 64 is diluted by the unintended voids or white space between pixels 66 resulting in an average lower optical density and therefore lowered contrast ratio even in the presence of an “ideal” 100% black ink.

FIG. 5 illustrates in enlarged detail a planned pixel placement to create an improved black rectangle 64 of FIG. 2. A matrix of 5 by 5 printed pixels 66 are enclosed by a barrier 82. Barrier 82 has been defined as the area that exists after adding (for instance) one row (top, bottom) and column (left, right) of pixels 66 to the original rectangle 64 in each dimension. This sharpens the boundary between pixels 66 and the barrier 82 along the perimeter of the rectangle 64 by reducing any bleeding of the image into the intended boundaries of barrier 82. The barrier 82 also allows excess ink to be applied to pixels 66 allowing enhanced coverage of the pixels 66 within rectangle 64. The foregoing is accomplished by “printing” with ink repellant, hydrophobic material, clear wax, or heat around an intended data element from a first print head to create a barrier around the intended data element and then printing a desired color ink from a second print head. This barrier prevents “bleeding” of the print pixels outside the intended printed barcode data elements to improve the print contrast ratio between the barcode data element and the background.

FIG. 6 illustrates in enlarged detail a black rectangle 64 of FIG. 5 that formed an almost solid black area 69 when ink was printed in the pixel 66 positions after barrier 82 was applied. The print quality and readability of rectangle 64 is improved because rectangle 64 is practically a solid black mass that contains virtually no white areas or unintended voids. Any number of barrier pixels may be added in different applications (more may be added at higher print resolutions) so long as they do not impinge upon intended print areas elsewhere. The adding may also be different in different directions. For instance, the manufacturing process of paper results in a “grain” of preferred fiber orientation. Ink may show unintended bleed differently along the grain of the paper than across the grain of the paper. Therefore the print area for barrier application may be added more along the long axis (with the grain) of the paper than across the grain.

A first print head to create barrier 82 may be a print cartridge containing a substance (wax or hydrophobic material) or a thermal print head used to apply heat. The second print head used to print pixels 66 is a colored ink or a black ink jet printer cartridge.

The present invention recognizes that a parameter which may be set to define the number of pixels added (possibly different in different axes) from the outer perimeter of a rectangle to ensure that the bleed of individual pixels does not cause them to extend beyond barrier 82.

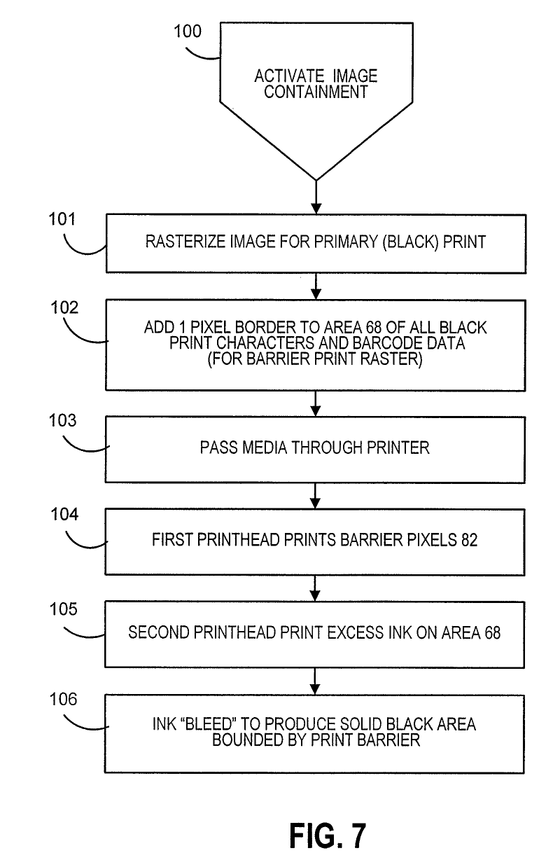

FIG. 7 is a process flow diagram of the printing of rectangle 64 of FIG. 6. The process begins in step 100 to activate image containment. Then in step 101 the image is rasterized for the printing of rectangle 64 with black ink. The process of image rasterization for printing is well known in the industry. Rasterization means that the original two dimensional image is converted into a series of strips (rows) by the computer. For each potential print pixel a determination is made as to whether it should be printed in black or left white. This raster data is then used to drive print commands or signals to the print head as it scans across the corresponding points on the unprinted paper. Now in step 102 the present invention adds 1 pixel outside the perimeter of area 68 of all black print characters and barcode data to create a separate barrier print raster. In step 103 the media (paper) is passed through the printer. As it passes through, in step 104 the first print head of the printer prints barrier pixels 82 around all rectangles 64 as directed by the barrier print raster data. Next in step 105 the second print head prints black ink on area 68. Now in step 106 ink “bleed” produces a solid black area 69 bounded by a barrier 82.

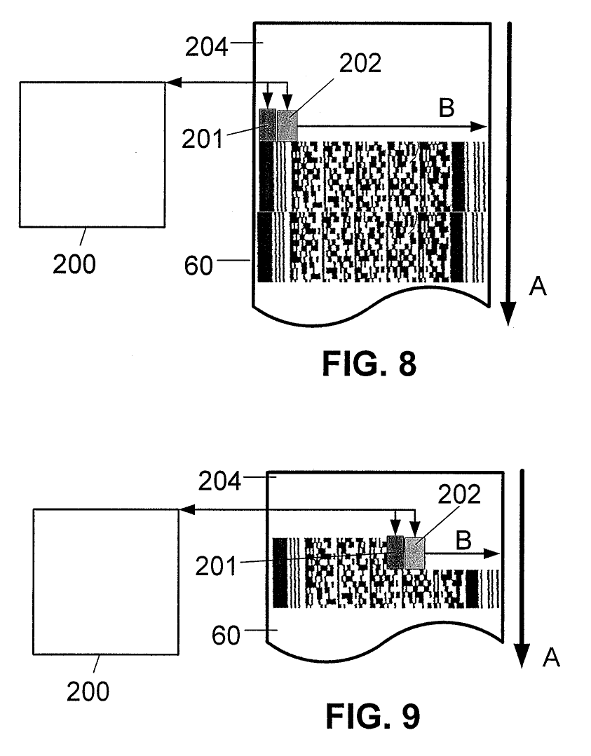

FIG. 8 is a drawing of the apparatus of this invention showing two print heads (ink and barrier) that print the enhanced barcode 60. Print head controller is coupled to print head 201 that ejects a black ink and controller 200 is coupled to print head 202 that produces the barrier for the aforementioned black ink. Controller 200 causes ink drops from print head 201 and barrier treatment from print head 202 to impact the paper 204 that moves in direction A. Print heads 201 and 202 move in direction B to print bar code 60. Barrier heads may be placed on either side of the ink head to allow bidirectional printing.

It would be obvious to one skilled in the art that controller 200 may be used to control various print heads that eject colored inks so that bar code 60 may be a bar code that has multiple colors.

FIG. 9 illustrates the black and barrier print heads (201, 202) as they progress across the paper (204) in direction B printing a strip of the rasterized barcode (60). Printed material is visible to the left of the print heads while the paper remains white in advance of the print operation to the right. When the print strip is complete, the paper will advance the height of a print strip, the print head will reset to the left position, and the print operation can repeat. The present invention recognizes that columns of pixels are printed simultaneously across the face of the print head as it advances across the paper but that pixels in subsequent strips will be printed with a significant latency. For this reason, under circumstances of fast drying and rapidly setting inks, it may be desirable to operate the pixel stripping algorithms only within the confines of each printing swatch rather than across the entire rasterized image. In this manner the barrier will be available to contain the inks before they set.

A further benefit of this invention is that the current practice of pixel trimming barcodes (removing a barcode of pixels from data elements to avoid the risk of bleed into white areas) is no longer necessary so higher quality barcodes with equal sized black 64 and white 65 rectangles is possible.

The extraordinary diversity of ink vendors, ink formulations, printers, and paper types make it impractical to define specific formulations and system parameters for use in the present invention. It is, however, possible to provide specific guidelines for their determination. First, each ink jet printer ink will have repellant (e.g. hydrophobic material for water based inks) and thermal barrier settings. If this material or treatment is applied before then ink is printed (dispersed) as described in this application then the ink will be constrained to the desired area.

The application describes the concept of taking the area to be printed and identifying surrounding “white” areas for application of the barrier treatment to prevent excessive spreading of the ink. A straightforward calibration process may be utilized to determine the desired print intensity, barrier strength and barrier pixel width. A monochrome black dot pattern, as presented in the application figures, may be printed and the unintended voids between pixels observed as well as the quality of test barcodes. Test patterns (A- Z) allow for a progressive series of dot or barcode tests in which the barrier strength and number of pixels boundary is varied:

TABLE 1
Matrix Describing Print Quality Test Barcodes

| Pixel | | % | Maximum | Barrier | |
|---|---|---|---|---|---|
| Border | 0% | 25% | 50% | 75% | 100% |
| 0 | A | B | C | D | E |
| 1 | F | G | H | I | J |
| 2 | K | L | M | N | O |
| 5 | P | Q | S | T | U |
| 10 | V | W | X | Y | Z |

The control test cases “A, F, K, P, and V” correspond to the instances in which no barrier treatment is applied (and therefore the pixel border is moot). At the opposite extreme, test cases in the final column represent instances in which the maximum barrier treatment is applied. Comparison of case “E” (no pixel border) to cases with progressively wider pixel borders (“J, O, U, Z”) will reveal the point at which the boundaries of the intended pattern become effective and the point (if any) at which the treatment causes unwanted image distortion. This barrier treatment typically allows the use of higher print densities than currently allowed and therefore the black ink quantity may be increased to maximum output as an additional parameter when running the barrier test matrix. An initial set of test patterns may be employed to determine the desired increase (if any) in black ink print intensity within the barcode data element rectangles 64 to reduce unwanted voids 67. The test pattern easily fits on a single sheet of paper and therefore the test print is accomplished quickly. Selection of the “best” pattern in which black and white pixels are of equal size without bleed could be done by visual inspection (as alignment patterns are done on many printers today) or through automation. An automated solution would be to utilize a barcode reader/verifier to read each of the printed barcodes and identify the point at which the read rates and quality are highest.

Since print media differ considerably in porosity (capacity for ink bleed), different settings would be expected to be required for blotting paper and plastic transparency film. Vendors might choose to pretest and calibrate their inks (they know what inks they sell with particular printer models) and incorporate the settings into the control systems or printer drivers for their printers. Printers that sense the paper media could then utilize the media types with the corresponding barrier material/local heat treatment strength and pixel border parameters.

The above specification describes a new and improved method for improving the readability of printed matter. It has been described with reference to black ink on white paper. It is realized that the above description may indicate to those skilled in the art additional ways in which the principles of this invention may be used without departing from the spirit including the use of any ink colors with the corresponding barriers to allow them to properly bleed within desired print areas while preventing unwanted bleed outside desired print areas thereby providing a better quality of print. It is, therefore, intended that this invention be limited only by the scope of the appended claims.

1. A method for forming bars of a barcode, said method comprising the steps of:
applying a barrier around an intended print area that retards spread of the printed pixels on a medium; and
printing pixels on the medium with an ink in the intended print area to improve a print contrast ratio between the barcode and the medium.

2. The method claimed in claim 1, wherein the barrier that retards the spread of pixels on the medium, is applied before the pixels are printed.

3. The method claimed in claim 1, wherein the barrier that retards the spread of pixels on the medium is applied after the pixels are printed.

4. The method claimed in claim 1, wherein the barrier that retards the spread of pixels is a hydrophobic material.

5. The method claimed in claim 1, wherein the spread of pixels is retarded by locally heating the medium.

6. The method claimed in claim 1, wherein the ink is applied in excess to cause growth of pixels into adjacent space on the medium within areas of continuous print.

7. The method claimed in claim 1, wherein the:
location of the barrier that retards the spread of pixels on a medium is determined by placing M pixel barriers outside the horizontal edges of the desired print areas.

8. The method claimed in claim 1, wherein the:
location of the barrier that retards the spread of pixels on a medium is determined by placing N pixel barriers outside the vertical edges of the desired print areas.

9. The method claimed in claim 1, wherein a:
subset of the printed pixels on the medium is determined for excess ink application during the rasterization of the image by decreasing the boundaries of the solid print areas by X pixels.

10. The method claimed in claim 1, wherein a:
subset of the printed pixels on the medium is determined for excess ink application during the rasterization of the image and;
includes information regarding the allocation of print data to separate print head passes and;
boundaries of the solid print areas within print head passes are decreased by Y pixels.
